(19) United States
(12) Patent Application Publication
(10) Pub. No.: US 2025/0256532 A1
(43) Pub. Date: Aug. 14, 2025

(54) TRANSPORT SYSTEM

(71) Applicant: WEISS GMBH, Buchen (Odw.) (DE)

(72) Inventors: Martin GÖTZINGER, Buchen (DE); Lutz NEUWEILER, Edingen-Neckarhausen (DE)

(21) Appl. No.: 19/050,660

(22) Filed: Feb. 11, 2025

(30) Foreign Application Priority Data
Feb. 14, 2024 (DE) 102024104076.9

(51) Int. Cl. B60B 33/00

(52) U.S. Cl. CPC B60B 33/0049; B60B 33/0065; B60Y 2200/34

(57) ABSTRACT

A transport system for transporting an object is provided including a transport rail and a transport trolley. The transport trolley includes a base body that is coupled or can be coupled to an object carrier for receiving an object to be transported. It also includes one caster unit including a first caster rotatably supported about a first axis of rotation, a second caster rotatably supported about a second axis of rotation and a third caster rotatably supported about a third axis of rotation. In addition there is a swivel caster unit having a swivel caster and a pivot section. The pivot section is rotatably supported at a base body about a pivot axis, and the swivel caster is rotatably supported at the pivot section about a swivel caster axis and cooperates with a running surface of the transport rail, the swivel caster axis and the pivot axis do not cross.

### CROSS-REFERENCES TO RELATED APPLICATIONS

This application claims the benefit of German Application No. 102024104076.9, filed Feb. 14, 2024. The entire disclosure of the application referenced above is incorporated herein by reference.

The present invention relates to a transport system for transporting objects.

Transport trolleys and corresponding transport systems are, for example, used in automation technology to transport objects from one location to another location, for example, from one production step to the next. For this purpose, the objects are positioned on transport trolleys and the transport trolleys are traveled along a rail. The rail can in this respect have straight and/or curved sections and can define a transport path that is closed in itself or an open transport path.

In practice, value is in particular placed on the cornering ability of the system since systems that are not capable of cornering operate discontinuously and their clock rates are limited. Furthermore, the rail systems should simultaneously have a high load-bearing capability and a good profile accuracy to be able to both transport high loads and ensure a high accuracy in the positioning of the transport trolleys and a low noise development during transport. As high as possible a positioning accuracy transverse to the direction of travel of the transport trolley on the rail is in particular intended to be ensured.

It is furthermore of essential importance that the transport trolleys or the transport systems work reliably and are nevertheless inexpensive in the manufacture and the assembly. In particular, as little wear as possible should occur at the transport trolleys, for example at the rollers of the transport trolleys.

In many systems, the transport rail has one or more straight transport sections and one or more curved sections that preferably have a constant radius. In a transition from a straight transport section to a curved section, the transport rail can have a course that is described by one or more functions (e.g. polynomials) that are calculated as part of complex optimization processes. However, the straight transport section can also merge directly into the curved section. The two sides of the rail can be described by different functions so that their course is not necessarily parallel.

However, the driving through of curved sections poses a particular challenge for conventional transport trolleys. A known type of transport trolley comprises, for example, one or more caster supports pivotable about a pivot axis that comprise casters that cooperate with lateral running surfaces of the transport rail and a load-bearing caster that cooperates with an upper running surface of the transport rail. Although this variant offers the advantage that the casters can align themselves along the transport rail during cornering, it is quite complex and maintenance-intensive since a comparatively large number of movable parts are used. In some applications, this variant has in particular proven to be less advantageous with respect to the positioning accuracy and the rigidity of the transport trolley transverse to the transport direction.

It is therefore the object of the invention to provide a transport system that satisfies all of the above-mentioned requirements.

The object is satisfied by a transport system according to claim 1.

A transport system according to the invention for transporting objects comprises at least one transport rail that comprises at least a first running surface, at least a second running surface and at least a third running surface. The first running surface and the second running surface are arranged disposed opposite one another. The third running surface extends perpendicular to and between the first and the second running surface. A surface normal of the third running surface defines an axial direction.

The first running surface, the second running surface and/or the third running surface are preferably designed as planar.

The transport system furthermore comprises at least one transport trolley. The transport trolley comprises a base body that is coupled or can be coupled to an object carrier for receiving at least one object to be transported. The object carrier can also be formed integrally with the base body.

As a rule, a plurality of transport trolleys are provided that are preferably individually controllable so that they can be moved independently of one another along the transport rail.

The transport trolley further comprises at least one caster unit comprising at least a first caster rotatably supported about a first axis of rotation, at least a second caster rotatably supported about a second axis of rotation and at least a third caster rotatably supported about a third axis of rotation. The first and the second caster are arranged at the base body such that the first and the second axis of rotation are stationary relative to the base body and such that said first and second caster cooperate with the first running surface. It is conceivable that further stationary casters are provided.

The third caster is arranged at the base body such that said third caster cooperates with the second running surface. The third caster can likewise be stationary relative to the base body. However, it can also be deflectably supported at the base body.

The first, the second and the third caster then preferably together at least partly engage around the transport rail. It is irrelevant in this respect from which spatial direction the casters (partly) engage around the transport rail. In principle, it would also be conceivable for the casters to be arranged within the transport rail. For example, the rail has the shape of a U in cross-section.

The transport trolley furthermore comprises at least one swivel caster unit comprising at least one swivel caster and at least one pivot section, wherein the pivot section is rotatably supported at the base body about a pivot axis. The swivel caster is rotatably supported at the pivot section about a swivel caster axis and cooperates with the third running surface. The transport trolley can also have a plurality of swivel caster units as required. It is also conceivable that a swivel caster unit has a plurality of swivel casters at respective pivot sections.

The swivel caster axis and the pivot axis do not cross or intersect. In other words, the swivel caster is eccentrically supported so that it aligns itself in the transport direction and “trails behind”. The eccentric support means that the swivel caster axis is arranged laterally offset with respect to the pivot axis, viewed in a direction transverse to the transport direction.

The swivel caster thereby automatically aligns itself when cornering so that it rolls reliably on the third running surface and does not slip or drag over it. This in turn reduces the wear at the transport trolley, which makes the transport system easier to maintain and more economical overall. Furthermore, there is little to no slippage at the rollers of the transport trolley and the transport trolley can carry comparatively large loads.

Furthermore, compared to the known transport trolley comprising a caster support, the embodiment according to the invention inter alia offers the advantage that the lateral casters and the upper, load-bearing roller can be constructionally separately arranged at the base body. The design of the transport trolley can thereby be greatly simplified overall, and indeed with a simultaneously significantly improved positioning accuracy and load capacity. At least some of the lateral casters can in particular be arranged in a stationary manner at the base body, whereas the load-bearing swivel caster can be separately and pivotably arranged at the base body, which significantly reduces the number of moving parts required. At the same time, an excellent cornering ability of the transport trolley is still ensured by the specific arrangement of the casters.

The number of casters (but at least three) and the number of swivel casters (but at least one) can generally be selected as required, for example to be able to reliably receive the loads occurring during the operation of the system and to simultaneously ensure a highly precise positioning of the transport trolley.

The drive of the transport trolley along the transport rail can, for example, take place mechanically, for example by means of a belt drive or a cam cylinder drive or the like, and/or electromagnetically, for example by means of a linear motor. Such drives are generally known.

Further embodiments of the invention are set forth in the claims, in the description and in the enclosed drawings.

According to one embodiment, the swivel caster axis is perpendicular to the pivot axis. This means that the swivel caster axis and the pivot axis form a right angle, viewed in the transport direction.

According to one embodiment, the pivot axis is arranged in parallel with the axial direction in a position of use of the transport trolley. In particular, the third running surface is the upper running surface of the transport rail in a position of use of the transport trolley so that substantially the entire weight load is received or carried by the swivel caster. This has the advantage that the transport trolley according to the invention can receive comparatively large loads without this having a negative effect on the positioning accuracy and the clock rate of the transport trolley since substantially no weight load acts on the casters.

According to one embodiment, the swivel caster axis is perpendicular to the first, the second and/or the third axis of rotation. However, an embodiment is also conceivable in which the swivel caster axis is arranged obliquely with respect to the first, second and/or third axis of rotation.

According to one embodiment, the first, the second and/or the third axis of rotation is arranged in parallel with the axial direction.

According to one embodiment, the third caster is arranged at the base body such that the third axis of rotation is stationary relative to the base body.

According to one embodiment, the third caster is arranged at the base body such that the third axis of rotation can be deflected relative to the base body, in particular in a direction perpendicular to the axial direction and perpendicular to a transport direction of the transport trolley. The third caster can, for example, be arranged at a pivot arm comprising a hinge or at a cantilever arm comprising a solid state joint or the like. The cornering ability of the transport trolley can thereby be improved and production tolerances can be efficiently compensated.

The caster unit can comprise two third casters that are rotatably supported at the base body about respective third axes of rotation and cooperate with the third running surface. The third casters can be arranged at the base body in a stationary or deflectable manner.

It is generally also conceivable that five or more casters are provided. The selection of the number of casters as required depends on the respective present requirement profile, for example on the size of the transport trolley and/or its load.

According to one embodiment with four casters, the first, the second and the two third axes of rotation form a trapezoid, in particular an isosceles trapezoid, viewed in the axial direction. A spacing between the two third casters can be smaller than a spacing between the first caster and the second caster. A particularly good cornering ability of the transport trolley can thereby be ensured. The spacings between the axes of rotation are preferably greater in the transport direction than in the transverse direction, which provides a particularly slender shape of the transport system and more stability.

According to one embodiment, the transport trolley comprises two swivel caster units that are arranged spaced apart from one another in the transport direction and that each comprise a swivel caster and each comprise a pivot section, wherein each of the two pivot sections is rotatably supported at the base body about a respective pivot axis and each of the two swivel casters is rotatably supported at the respective pivot section about a respective swivel caster axis, wherein the respective swivel caster axes and pivot axes do not cross or intersect. In particular, a spacing between the two pivot axes of the two pivot sections is greater than a spacing between the first axis of rotation and the second axis of rotation. A better stability against a tilting of the transport trolley in the transport direction is thereby achieved.

According to one embodiment, the transport system further comprises a carrier section that extends from the base body in the axial direction. The carrier section and the base body can be formed in one piece or can be separate components.

According to one embodiment, the transport trolley comprises, in addition to the at least one caster unit arranged at the base body (base body-side caster unit), at least one caster unit arranged at the carrier section, wherein first and second casters of the caster unit arranged at the carrier section (carrier-side caster unit) cooperate with first and second running surfaces of a second transport rail of the transport system.

According to one embodiment, the carrier-side caster unit is configured in a manner corresponding to the base body-side caster unit or comprises, for example, more or fewer and/or geometrically differently arranged casters.

According to one embodiment, the carrier-side caster unit is arranged axially at the center below the base body-side caster unit. For example, the axes of rotation of the casters of the caster unit arranged at the carrier are aligned with the axes of rotation of the casters of the caster unit arranged at the base body.

According to one embodiment, the carrier-side caster unit is arranged offset with respect to the base body-side caster unit in the transport direction. For example, a carrier-side caster unit can preferably be arranged equidistantly between two base body-side caster units in the transport direction. Alternatively, a base body-side caster unit can also preferably be arranged equidistantly between two carrier-side caster units in the transport direction. However, it is also conceivable that exactly one caster unit arranged at the base body is arranged in front of or behind exactly one caster unit arranged at the carrier in the transport direction. In this respect, the base body-side caster unit and the carrier-side caster unit can at least partly overlap or not overlap, viewed in the axial direction.

According to one embodiment, the second transport rail is configured like the first transport rail, i.e. the second transport rail can have corresponding first, second and third running surfaces. However, it is also conceivable that the second transport rail is dimensioned differently to the first transport rail.

According to one embodiment, the second transport rail is arranged axially at the center below the first transport rail.

According to one embodiment, the transport trolley comprises, in addition to the at least one swivel caster unit arranged at the base body (base body-side swivel caster unit), at least one swivel caster unit arranged at the carrier section (carrier-side swivel caster unit). The swivel caster unit can cooperate with a second transport rail, in particular with the above-described second transport rail that is in contact with casters of a carrier-side caster unit.

According to one embodiment, the swivel caster of the swivel caster unit arranged at the carrier section cooperates with a fourth running surface, disposed opposite the third running surface, of the first transport rail of the transport system, wherein the fourth running surface of the first transport rail is a lower one of the running surfaces of the first transport rail in the position of use of the transport trolley.

According to one embodiment, the swivel caster of the swivel caster unit arranged at the carrier section cooperates with a third running surface of the second transport rail of the transport system, wherein the third running surface of the second transport rail is an upper one of the running surfaces of the second transport rail in the position of use of the transport trolley. A better load distribution is thereby achieved.

According to one embodiment, the swivel caster of the swivel caster unit arranged at the carrier section cooperates with a fourth running surface of the second transport rail of the transport system, said fourth running surface being disposed opposite the third running surface of the second transport rail, wherein the fourth running surface of the second transport rail is a lower one of the running surfaces of the second transport rail in the position of use of the transport trolley.

According to one embodiment, the swivel caster of the base body-side swivel caster unit that cooperates with the third running surface of the first transport rail is preloaded with respect to the swivel caster of the carrier-side swivel caster unit that cooperates with the fourth running surface of the first transport rail. Alternatively or additionally, the carrier-side swivel caster unit is preloaded.

A particularly uniform, stable and low-friction operation of the transport trolley is ensured by preloading the swivel caster unit. The preload can be provided by at least one elastic element and presses the swivel caster unit or the swivel caster against the corresponding third or fourth running surface in or parallel to the direction of the pivot axis.

According to one embodiment, the carrier-side swivel caster unit is arranged axially at the center below the base body-side swivel caster unit, i.e. the pivot axis of the swivel caster of the base body-side swivel caster unit is aligned with the pivot axis of the swivel caster of the carrier-side swivel caster unit.

According to one embodiment, the carrier-side swivel caster unit is arranged offset with respect to the base body-side swivel caster unit in the transport direction. For example, a carrier-side swivel caster unit can preferably be arranged equidistantly between two base body-side swivel caster units in the transport direction. Alternatively, a base body-side swivel caster unit can preferably also be arranged equidistantly between two carrier-side swivel caster units in the transport direction. However, it is also conceivable that exactly one swivel caster unit arranged at the base body is arranged in front of or behind exactly one swivel caster unit, which is arranged at the carrier, in the transport direction. In this respect, the base body-side swivel caster unit and the carrier-side swivel caster unit can at least partly overlap or not overlap, viewed in the axial direction.

According to one embodiment, the carrier-side swivel caster unit is configured in a manner corresponding to the base body-side swivel caster unit or comprises more or fewer and/or (one) geometrically differently arranged swivel caster(s).

According to one embodiment, at least one guide element is arranged at the carrier section and cooperates with a fourth running surface of the transport rail, in particular wherein the fourth running surface is disposed opposite the third running surface. However, it is also conceivable that a separate transport rail is provided for the fourth running surface.

According to one embodiment, the guide element is arranged at the carrier section such that the guide element is pressed with a preload against the fourth running surface. The guide element therefore acts as a kind of counter-pressure element for the swivel caster(s).

According to one embodiment, the guide element is arranged centrally between the two pivot axes of the two swivel caster units, viewed in the axial direction. The clamping force is therefore uniformly distributed over the swivel casters.

According to one embodiment, the guide element is a roller rotatably supported at the carrier section, wherein an axis of rotation of the roller is arranged in parallel with the swivel caster axis. The guide element thereby cooperates with the fourth running surface with particularly low friction, which leads to particularly little abrasion at the guide element. This in turn makes the transport system more energy-efficient since less drive energy is required. However, the guide element can also be designed as a guide carriage or similar that can slide along the fourth running surface with as little friction as possible.

According to one embodiment, the transport rail has a rectangular cross-sectional shape, viewed in the transport direction. The running surfaces of the casters and/or the running surface(s) of the swivel caster(s) in particular do not have a V shape and/or the running surfaces of the transport rail do not have a wedge shape. However, a configuration is also conceivable in which only the running surface of the swivel caster has a V shape and the third running surface of the transport rail has a wedge shape.

The invention will be explained in more detail in the following purely by way of example with reference to advantageous embodiments and to the Figures. In these, there are shown:

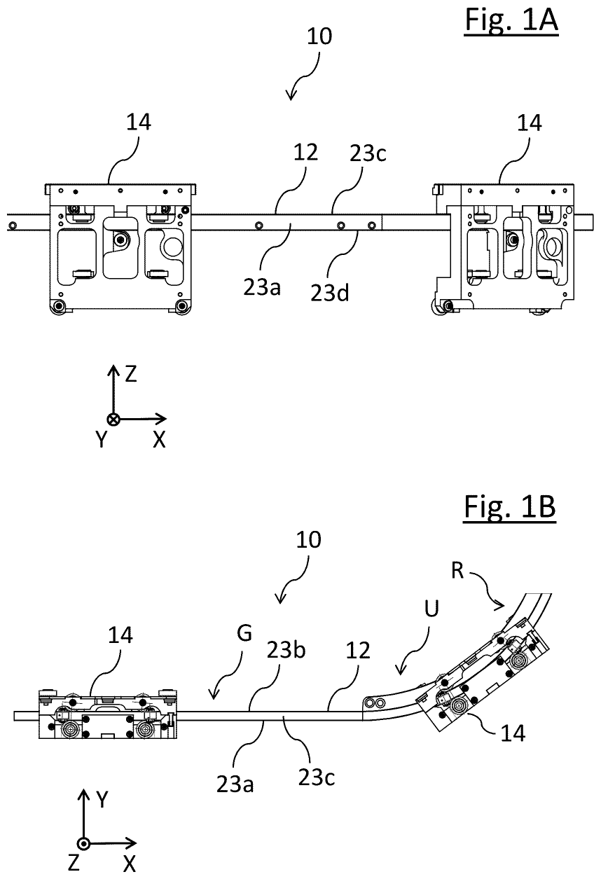

FIG. 1A: a simplified side view of a section of a transport system;

FIG. 1B: a plan view of the transport system of FIG. 1A;

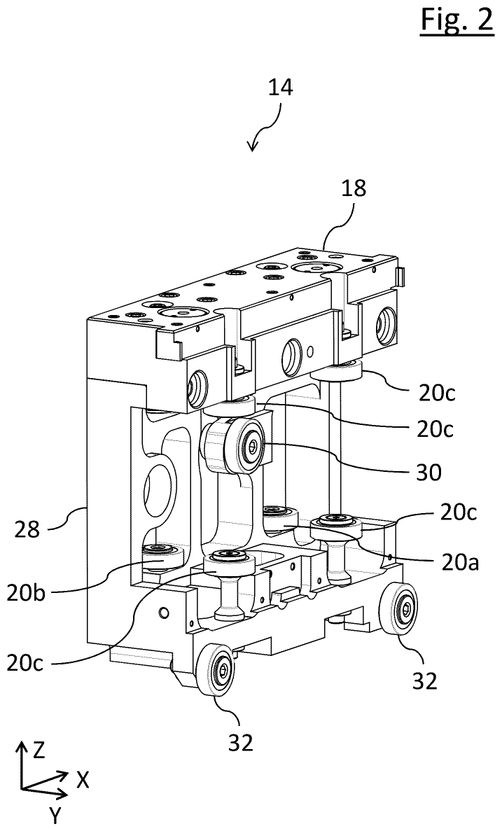

FIG. 2: a simplified perspective view of a transport trolley;

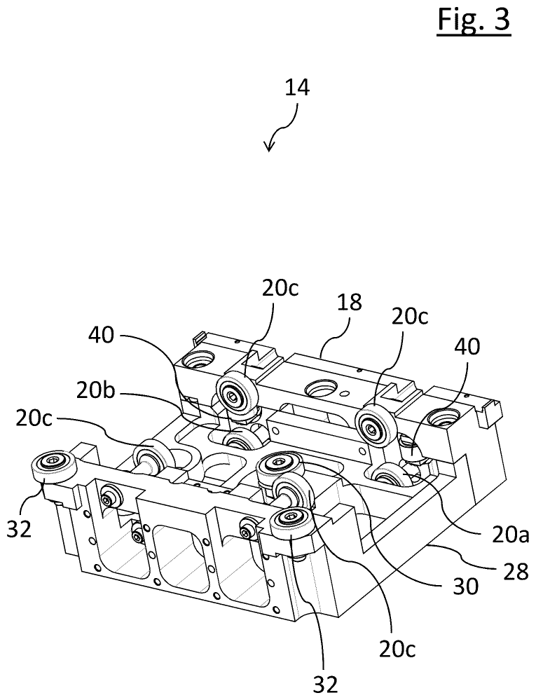

FIG. 3: a further perspective view of the transport trolley;

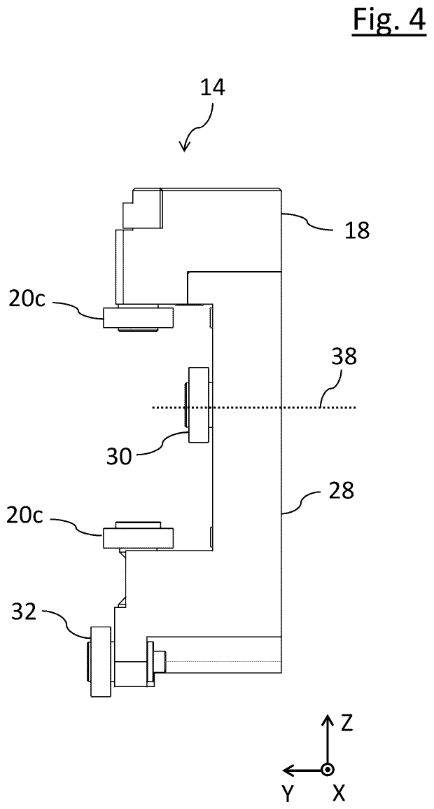

FIG. 4: a side view of the transport trolley;

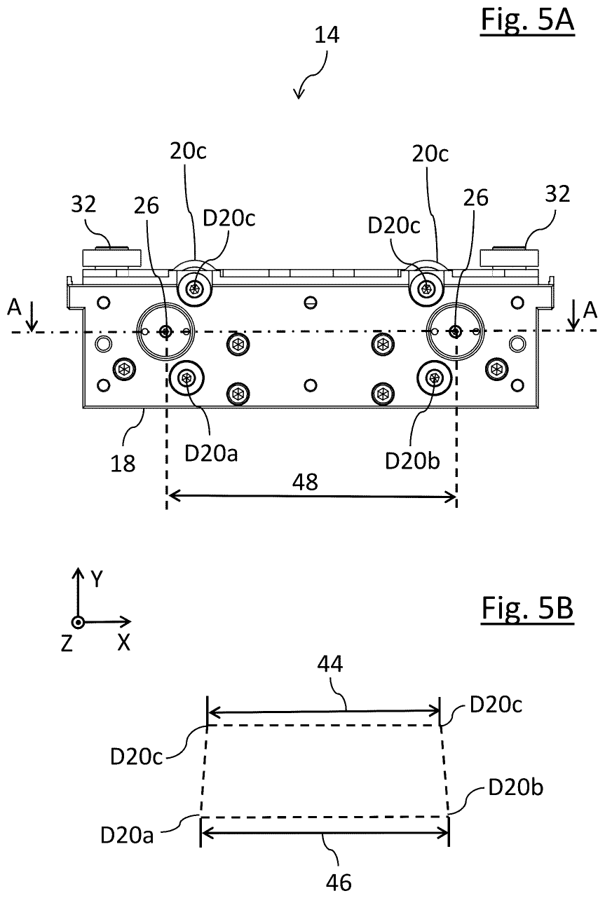

FIG. 5A: a plan view of the transport trolley;

FIG. 5B: a schematic representation of the arrangement of the axes of rotation of the casters;

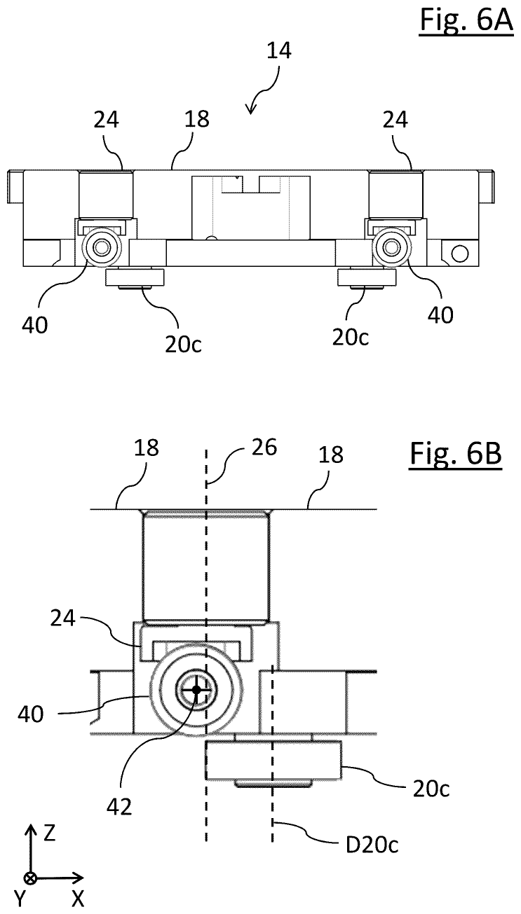

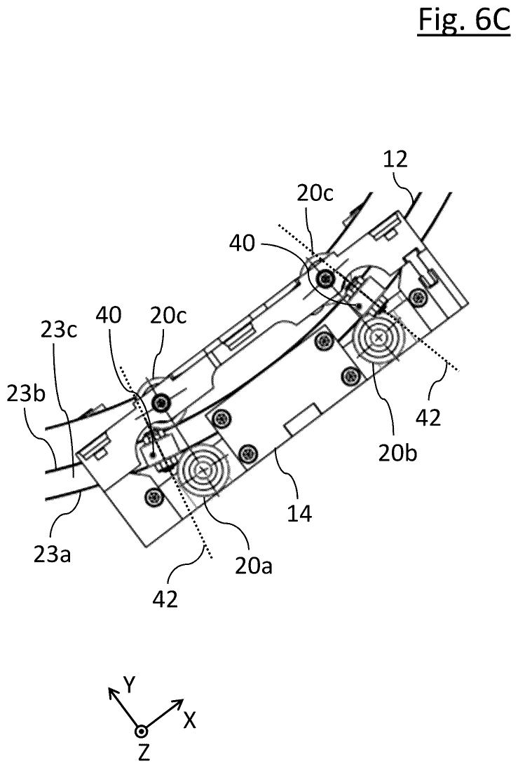

FIG. 6A: a sectional view of the base body of the transport trolley along the sectional line A-A drawn in FIG. 5A;

FIG. 6B: an enlarged representation of a part of a swivel caster unit; and

FIG. 6C: a simplified plan view of a section of the transport system of FIG. 1A in a horizontal section through the transport trolley.

The transport system 10 shown in FIGS. 1A and 1B has a transport rail 12 comprising two lateral running surfaces 23a, 23b, an upper running surface 23c and a lower running surface 23d along which one or more transport trolleys 14 can be moved in a transport direction X. The coordinate system refers to the transport trolley 14.

For the sake of simplicity, the system 10 is only partly shown. Components not necessary for the understanding of the present invention have been omitted. The first running surface 23a and the second running surface 23b are arranged disposed opposite one another. The same applies to the third and the fourth running surface 23c, 23d. The third running surface 23c extends perpendicular to and between the first and the second running surface 23a, 23b. The transport rail 12 has a rectangular cross-sectional shape, viewed in the transport direction X.

A surface normal of the third running surface 23c defines an axial direction Z. A transverse direction Y is to be understood as a direction that is arranged perpendicular to the axial direction Z and perpendicular to a transport direction X of the transport trolley 14 along the transport rail 12.

The drive of the transport trolley 14 along the transport rail 12 can, for example, take place mechanically (e.g. by means of a belt drive and/or cam cylinder drive or the like) and/or electromagnetically (e.g. by means of a linear motor or the like).

As can be seen in the plan view of the transport system 10 shown in FIG. 1B, the transport system 10 in the present embodiment example has a section G with a straight transport path that merges via a transition section U into a curved section R that has a constant radius of curvature. It is understood that, in contrast to the example shown, transport rails can be realized with any desired path guidance. It is furthermore understood that the transport rail 12 can define a path closed in itself.

Along the transport path defined by the transport rail 12, processing stations can, for example, be provided at which workpieces arranged on the transport trolley 14 can be processed. The design of the rail 12 can be modular so that individual modules with specific lengths and/or specific radii of curvature can be easily combined with one another to obtain a transport system 10 having the desired configuration.

FIG. 2 shows a perspective view of a transport trolley 14. For the sake of simplicity, components of the transport trolley 14 that are not essential to the idea of the invention are not shown here either. In the embodiment example shown, the drive of the transport trolley 14 takes place at least sectionally by a cam cylinder drive, not shown, in which drive rollers 32 of the transport trolley 14 engage into spiral grooves of a transport roller, not shown, that rotates about its longitudinal axis to move the transport trolley 14 along the transport direction X. Such drives are generally known and are characterized by a particularly high reliability and precision. It is understood that the transport trolley 14 can, however, also be driven by other drive means, for example by means of a belt drive and/or a linear motor.

As can be clearly seen in the further perspective view of the transport trolley 14 shown in FIG. 3, the transport trolley 14 comprises a (multi-piece) base body 18 at which a first caster 20a and a second caster 20b are supported. They are spatially fixed relative to the base body 18 and cooperate with the running surface 23a arranged at a side of the transport rail 12 (see FIGS. 1A, 1B). The first caster 20a is rotatably supported at the base body 18 about a first axis of rotation D20a and the second caster 20b is rotatably supported at the base body 18 about a second axis of rotation D20b (see FIG. 5A). The first and second axis of rotation D20a, D20b are arranged in parallel with one another and in parallel with the axial direction Z. It is understood that more than two casters can cooperate with the running surface 23a of the transport rail 12.

Furthermore, two third casters 20c are supported at the base body 18. They are likewise spatially fixed relative to the base body 18 and cooperate with the running surface 23b arranged at the oppositely disposed side of the transport rail 12 (see FIGS. 1A, 1B). The third casters 20c are rotatably supported at the base body 18 about respective third axes of rotation D20c (see FIG. 5A). The third axes of rotation D20c are arranged in parallel with one another and in parallel with the axial direction Z. It is understood that only one third caster 20c can also be provided, or more than two, for example three.

So that the transport trolley 14 can continue to move precisely and smoothly along the transport rail 12, the base body 18 further has two swivel casters 40. The arrangement and function of the swivel casters 40 is described in more detail below with reference to FIGS. 6A to 6C.

The transport trolley 14 comprises an (optional) carrier section 28 that extends downwardly from the base body 18 in the axial direction Z in the position of use. In the embodiment example shown, the carrier section 28 and the base body 18 are separate components. The carrier section 28 and the base body 18 can also be formed in one piece.

An additional first caster 20a and an additional second caster 20b are supported at a section of the carrier section 28 disposed opposite the base body 18. They are spatially fixed relative to the carrier section 28 and cooperate with a first running surface of a second transport rail, not shown, of the transport system 10. Furthermore, two additional third casters 20c are supported at the carrier section 28. Precisely these casters are likewise spatially fixed relative to the carrier section 28 and cooperate with a second running surface of the second transport rail, not shown, of the transport system 10, wherein the first running surface is disposed opposite the second running surface.

The lower first casters 20a, which are arranged at the carrier section 28, are disposed opposite the upper first casters 20a arranged at the base body 18, i.e. the respective first axes of rotation D20a are aligned in the axial direction Z. The same applies to the axes of rotation D20b, D20c of the second and third casters 20b, 20c. However, the lower and upper casters can also, as required, be arranged offset from one another in transport direction X.

Since not only the upper casters 20a, 20b, 20c arranged at the base body 18, but also the lower casters 20a, 20b, 20c arranged at the carrier section 28 run along a respective transport rail 12 of the transport system 10, the transport trolley 14 is particularly resistant to tilting in the transverse direction Y.

The running surfaces 23a, 23b, 23c of the transport rail 12 are each designed as planar, i.e. they in particular do not have a wedge shape. The same applies to the running surfaces of the second transport rail, not shown, of the transport system 10.

As can be seen in the plan view in FIG. 5A, the axes of rotation D20a, D20b, D20c of the casters 20a, 20b, 20c form an isosceles trapezoid, viewed in the axial direction Z, in which a spacing 44 between the two third casters 20c is smaller than a spacing 46 between the first caster 20a and the second caster 20b (see FIG. 5B). This arrangement of the casters 20a, 20b, 20c makes the transport trolley 14 particularly suitable for cornering.

However, the arrangement of the casters 20a, 20b, 20c is not to be understood as limited to the trapezoidal shape. For example, in particular in the case of purely linear rail paths, the axes of rotation D20a, D20b, D20c of the casters 20a, 20b, 20c can also form a rectangle, in particular a square. Furthermore, in a case in which only a third caster 20c is provided, the axes of rotation D20a, D20b, D20c of the casters 20a, 20b, 20c can form an isosceles triangle, in particular an equilateral triangle.

In the embodiment example shown, the third casters 20c are arranged in a stationary manner at the base body 18 or the carrier section 28, which makes the transport trolley particularly easy to maintain and durable since fewer moving parts are used. However, to be able to better compensate production tolerances of the transport rail 12 and to make the transport trolley 14 even more capable of cornering, at least one or more of the third casters 20c can also be arranged at the base body 18 or the carrier section 28 such that the third axis of rotation D20c can be deflected relative to the base body 18 or the carrier section 28, preferably substantially only in the transverse direction Y. The deflectable support of the third caster 20c can, for example, take place by means of a cantilever arm that extends from the base body 18 or the carrier section 28 and that comprises an elastically acting solid state joint (not shown). However, the deflectable support of the third caster 20c can also be achieved by means of a pivot arm that extends from the base body 18 or the carrier section 28 and comprises a rotatably supported pivot axis or the like (likewise not shown).

As shown in FIG. 6A and in the enlarged representation in FIG. 6B, swivel casters 40 are provided that are rotatably supported at a pivot section 24 about a swivel caster axis 42. The pivot section 24 is in turn rotatably supported at the base body 18 about a pivot axis 26 (see also FIG. 5A). The swivel caster axis 42 and the pivot axis 26 are arranged laterally offset from one another viewed in the transverse direction Y, i.e. they do not cross or intersect. The swivel caster axis 42 is perpendicular to the pivot axis 26 and perpendicular to the axes of rotation D20a, D20b, D20c of the casters 20a, 20b, 20c. The pivot axis 26 is arranged in parallel with the axial direction Z in a position of use of the transport trolley 14 (see FIG. 6B).

The swivel caster axis 42 is always perpendicular to the transport direction X, irrespective of the current position of the transport trolley 14 on the transport rail 12, i.e. in particular irrespective of whether the transport trolley 14 is currently located on the section with the straight transport path G, the transition section U or the curved section R. In other words, the swivel caster 40 aligns itself along the transport direction X and therefore rolls substantially without sliding friction on the upper, third running surface 23c of the transport rail 12. To illustrate this, the swivel caster axes 42 of the swivel casters 40 are marked with dashed lines in the simplified detailed view of FIG. 6C.

The swivel casters 40 substantially bear the entire weight of the trolley 14 and of a product arranged thereon without canting or sliding obliquely over the upper running surface 20c in the process. The transport trolley 14 can therefore transport comparatively large loads, while it can simultaneously be positioned with high precision on the transport rail 12. Furthermore, the wear at the casters 20a, 20b, 20c is significantly reduced, which makes the transport system 10 more maintenance-friendly, more durable and more economical overall.

As shown in FIG. 5A, the two pivot axes 26 of the two swivel casters 40 are arranged spaced apart from one another in the transport direction X at the base body 18. A spacing 48 between the pivot axes 26 is greater than the spacing 44 between the third axes of rotation D20c and the spacing 46 between the first and second axis of rotation D20a, D20b (see FIG. 5B). The inclined position of the transport trolley 14 is thereby reduced.

Furthermore, the pivot axes 26 lie between the first and third axis of rotation D20a, D20c and between the second and third axis of rotation D20b, D20c with respect to the transverse direction Y. Furthermore, the two pivot axes 26 are arranged equidistantly with respect to the center of the base body 18. They are furthermore arranged such that the swivel casters 40 come to lie centrally on the third running surface 23c. This specific arrangement of the pivot axes 26 and axes of rotation D20a, D20b, D20c makes the transport trolley 14 particularly stable against tilting.

According to an embodiment, not shown, the transport trolley 14 comprises only one instead of two swivel casters 40 of the initially described kind. The swivel caster 40 is supported centrally between the casters 20a, 20b, 20c at the base body 18 by means of a pivot section 24, i.e. a spacing between the pivot axis 26 and the first axis of rotation D20a is equal to a spacing between the pivot axis 26 and the second axis of rotation D20b.

However, a configuration is also possible in which the transport trolley 14 comprises three or more swivel casters 40 that are arranged distributed along the transport direction X at the base body 18 (e.g. equidistantly spaced apart). This design makes the transport trolley 14 particularly suitable for large loads since the weight is distributed over a plurality of swivel casters 40.

According to an embodiment, not shown, the transport trolley 14 in addition also comprises one or more swivel casters 40 of the initially described kind that are arranged at the carrier section 28. These swivel casters 40 can be arranged opposite to or offset in relation to the swivel casters 40 arranged at the base body 18 and cooperate with a third running surface of the second transport rail of the transport system 10. There may be a preload between the carrier-side swivel casters 40 and the base body-side swivel caster unit 40, which provides additional stability.

As can be particularly clearly seen in FIGS. 2 to 4, the transport trolley 14 furthermore comprises a guide element 30 that cooperates with the lower, fourth running surface 23d of the transport rail 12 (see FIG. 1A). Viewed in the axial direction Z, the guide element 30 is arranged centrally between the two pivot axes 26 of the two swivel caster units and the carrier section 28.

In the embodiment example shown, the guide element 30 is configured as a roller that is rotatably supported at the carrier section 28 and whose axis of rotation 38 is arranged in parallel with the swivel caster axis 42 (see FIG. 4).

Furthermore, the guide element 30 is arranged at the carrier section 28 such that it is pressed with a preload against the fourth running surface 23d. In other words, the transport rail 12 is clamped between the swivel casters 40 and the guide element 30. The guide element 30 therefore acts as a kind of counter-pressure element that stabilizes the rolling movement of the swivel casters 40 on the third running surface 23c. A stable seat of the transport trolley 14 on the transport rail 12 is thereby ensured, in particular even with high longitudinal acceleration rates and/or small loads. The magnitude of the preload can be selected as required to ensure an optimum seat of the transport trolley 14. Due to the design as a roller, the guide element 30 cooperates with the fourth running surface 23d with particularly low wear. Furthermore, little energy is required to move the transport trolley 14.

However, the guide element 30 can also be configured as a guide carriage that cooperates with the fourth running surface 23d (not shown) in a preloaded manner. The surface of the guide carriage can be particularly smooth and/or lubricated to reduce the sliding friction between the guide carriage and the fourth running surface 23d. Such a design makes the transport trolley 14 less complex.

In addition to the guide element 30 cooperating with the fourth running surface 23d of the transport rail 12, the transport trolley 14 can comprise at least one guide element cooperating with a fourth running surface of the second transport rail of the transport system 10.

Furthermore, it is understood that the widths of the rollers 20a, 20b, 20c, 30, 40 and the widths of the running surfaces 23a, 23b, 23c, 23d are matched to one another.

The described arrangements and designs of the casters 20a, 20b, 20c, the swivel casters 40 and the guide element 30 as well as their number can be combined as desired.

The interplay according to the invention of lateral casters 20a, 20b, 20c and swivel casters 40 offers several advantages. The load of the transport trolley 14 is received with low friction by the self-aligning swivel casters 40 following in the transport direction X. The lateral casters 20a, 20b, 20c can thereby ensure a highly precise positioning of the transport trolley 14 in the transverse direction Y without interference. Due to an optional preload—provided, for example, by a corresponding guide element 30 and/or additional, axially preloaded swivel casters 40—the swivel casters 40 cooperate with the third running surface 23c without slippage since they are pressed against the third running surface 23c not only by the load, but also by the preload provided by the guide element 30. This can in particular be advantageous when the transport trolley 14 is emptied. Furthermore, the number of moving parts—compared to conventional systems—is significantly reduced, which makes the transport system more economical and robust overall.

A transport system for transporting objects comprises at least one transport rail that comprises at least a first running surface, at least a second running surface and at least a third running surface, wherein the first running surface and the second running surface are arranged disposed opposite one another, wherein the third running surface extends perpendicular to and between the first and the second running surface and a surface normal of the third running surface defines an axial direction. The transport system furthermore comprises at least one transport trolley. The transport trolley comprises a base body that is coupled or can be coupled to an object carrier for receiving at least one object to be transported. The transport trolley furthermore comprises at least one caster unit comprising at least a first caster rotatably supported about a first axis of rotation, at least a second caster rotatably supported about a second axis of rotation and at least a third caster rotatably supported about a third axis of rotation. The first and the second caster are arranged at the base body such that the first and the second axis of rotation are stationary relative to the base body and such that said first and second caster cooperate with the first running surface. The third caster is arranged at the base body such that said third caster cooperates with the second running surface. The transport trolley further comprises at least one swivel caster unit comprising at least one swivel caster and at least one pivot section. The pivot section is rotatably supported at the base body about a pivot axis. The swivel caster is rotatably supported at the pivot section about a swivel caster axis and cooperates with the third running surface. The swivel caster axis and the pivot axis do not cross or intersect.

### REFERENCE NUMERAL LIST

10 transport system
12 transport rail
14 transport trolley
18 base body
20a-20c casters
D20a-D20c axes of rotation
23a-23c running surfaces
24 pivot section
26 pivot axis
28 carrier section
30 guide element
32 drive rollers
38 axis of rotation
40 swivel caster
42 swivel caster axis
44, 46 spacings of the axes of rotation
48 spacing of the pivot axes
X transport direction
Y transverse direction
Z axial direction
G section with a straight transport path
U transition section
R curved section

1. A transport system for transporting objects, said transport system comprising:
at least one transport rail that comprises at least a first running surface, at least a second running surface and at least a third running surface, wherein the first running surface and the second running surface are arranged disposed opposite one another, wherein the third running surface extends perpendicular to and between the first and the second running surface and a surface normal of the third running surface defines an axial direction; and
at least one transport trolley comprising:
a base body that is coupled or can be coupled to an object carrier for receiving at least one object to be transported;
at least one caster unit comprising at least a first caster rotatably supported about a first axis of rotation, at least a second caster rotatably supported about a second axis of rotation and at least a third caster rotatably supported about a third axis of rotation, wherein the first and the second caster are arranged at the base body such that the first and the second axis of rotation are stationary relative to the base body and such that said first and second caster cooperate with the first running surface, wherein the third caster is arranged at the base body such that said third caster cooperates with the second running surface, and
at least one swivel caster unit comprising at least one swivel caster and at least one pivot section, wherein the pivot section is rotatably supported at the base body about a pivot axis, wherein the swivel caster is rotatably supported at the pivot section about a swivel caster axis and cooperates with the third running surface, wherein the swivel caster axis and the pivot axis do not cross.

2. The transport system according to claim 1,
wherein the swivel caster axis is perpendicular to the pivot axis.

3. The transport system according to claim 1,
wherein the pivot axis is arranged in parallel with the axial direction in a position of use of the transport trolley.

4. The transport system according to claim 1,
wherein the swivel caster axis is perpendicular to the first, the second and/or the third axis of rotation.

5. The transport system according to claim 1,
wherein the first, the second and/or the third axis of rotation is arranged in parallel with the axial direction.

6. The transport system according to claim 1,
wherein the third caster is arranged at the base body such that the third axis of rotation is stationary relative to the base body.

7. The transport system according to claim 1,
wherein the third caster is arranged at the base body such that the third axis of rotation can be deflected relative to the base body.

8. The transport system according to claim 7,
wherein the first, the second and the two third axes of rotation form a trapezoid viewed in the axial direction.

9. The transport system according to claim 1,
wherein the transport trolley comprises two swivel caster units that are arranged spaced apart from one another in the transport direction and that each comprise a swivel caster and each comprise a pivot section, wherein each of the two pivot sections is rotatably supported at the base body about a respective pivot axis and each of the two swivel casters is rotatably supported at the respective pivot section about a respective swivel caster axis, wherein the respective swivel caster axes and pivot axes do not cross.

10. The transport system according to claim 1,
further comprising a carrier section that extends from the base body in the axial direction.

11. The transport system according to claim 10,
wherein the transport trolley comprises, in addition to the at least one caster unit arranged at the base body, at least one caster unit arranged at the carrier section,
wherein first and second casters of the caster unit arranged at the carrier section cooperate with first and second running surfaces of a second transport rail of the transport system.

12. The transport system according to claim 10,
wherein the transport trolley comprises, in addition to the at least one swivel caster unit arranged at the base body, at least one swivel caster unit arranged at the carrier section.

13. The transport system according to claim 10,
wherein at least one guide element is arranged at the carrier section and cooperates with a fourth running surface of the transport rail, wherein the fourth running surface is disposed opposite the third running surface.

14. The transport system according to claim 13,
wherein the guide element is arranged at the carrier section such that the guide element is pressed with a preload against the fourth running surface.

15. The transport system according to claim 13,
wherein the transport trolley comprises two swivel caster units that are arranged spaced apart from one another in the transport direction and that each comprise a swivel caster and each comprise a pivot section, wherein each of the two pivot sections is rotatably supported at the base body about a respective pivot axis and each of the two swivel casters is rotatably supported at the respective pivot section about a respective swivel caster axis, wherein the respective swivel caster axes and pivot axes do not cross, wherein the guide element is arranged centrally between the two pivot axes of the two swivel caster units, viewed in the axial direction.

16. The transport system according to claim 12,
wherein the guide element is a roller rotatably supported at the carrier section, wherein an axis of rotation of the roller is arranged in parallel with the swivel caster axis.

17. The transport system according to claim 1,
wherein the transport rail has a rectangular cross-sectional shape, viewed in the transport direction.

18. The transport system according to claim 7,
wherein the third caster is arranged at the base body such that the third axis of rotation can be deflected in a direction perpendicular to the axial direction and perpendicular to a transport direction of the transport trolley.

19. The transport system according to claim 7,
wherein the caster unit comprises two third casters that are rotatably supported at the base body about respective third axes of rotation and cooperate with the third running surface.

20. The transport system according to claim 8,
wherein a spacing between the two third casters is smaller than a spacing between the first caster and the second caster.

21. The transport system according to claim 9,
wherein a spacing between the two pivot axes of the two pivot sections is greater than a spacing between the first pivot axis and the second pivot axis.

22. The transport system according to claim 10,
wherein the carrier section and the base body are formed in one piece or are separate components.

23. The transport system according to claim 12,
wherein the swivel caster unit cooperates with a second transport rail.
